(19) United States
(12) Patent Application Publication
(10) Pub. No.: US 2007/0036050 A1
(43) Pub. Date: Feb. 15, 2007

(54) Anykey function executing device of optical disc system and method of executing anykey function

(75) Inventor: Jin Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/498,867

(22) Filed: Aug. 4, 2006

(30) Foreign Application Priority Data
Aug. 10, 2005 (KR) 2005-73472

(51) Int. Cl. G11B 20/00

(52) U.S. Cl. 369/47.16

(57) ABSTRACT

A method of executing an anykey function of an optical disc system, the optical disc system including a recording/reproducing deck and a recording deck, the method including determining a type of an enabled deck; determining a type of an optical disc inserted in the enabled deck; and selecting a list of menus to be displayed from a list of available menus based on the type of the enabled deck and the type of the optical disc inserted in the enabled deck in response to operation of an anykey.

### CROSS-REFERENCE TO RELATED APPLICATION

This application claims the benefit of Korean Patent Application No. 2005-73472 filed on Aug. 10, 2005, in the Korean Intellectual Property Office, the disclosure of which is incorporated herein by reference.

### BACKGROUND OF THE INVENTION

1. Field of the Invention

An aspect of the invention relates to an optical disc system, and more particularly to an anykey function executing device of an optical disc system that is capable of enhancing an anykey function, and a method of executing the anykey function. An optical disc system according to an aspect of the invention has dual decks, one of which is a recording/reproducing deck operable to record data on and reproduce data from an optical disc, and the other of which is a reproducing deck operable only to reproduce data from an optical disc.

2. Description of the Related Art

Recently, an optical disc system having two decks, referred to as a dual-deck optical disc system, has been developed to record data on and reproduce data from optical discs. The dual-deck optical disc system may be configured so that both decks can perform both a recording operation and a reproducing operation, or so that one deck can perform both a recording operation and a reproducing operation, and the other deck can perform only a reproducing operation.

Operations of the optical disc system, such as a recording operation and a reproducing operation, are performed using a remote controller having a menu key, a movement key, and an anykey. An anykey is a type of hot key.

The anykey simplifies complicated operations in which a certain function of an optical disc system is executed after one or more selections are made on one or more submenus displayed in sequence. Namely, when the anykey is operated in a one-touch operation, a list of frequently used menus is displayed so that users can easily select a desired one of the menus.

When an optical disc inserted in a deck is a recordable medium, i.e., a medium that in a current state can be both recorded and reproduced, the anykey serves to display a list of frequently used menus related to both a recording operation and a reproducing operation. When the optical disc inserted in a deck is a reproducible-only medium, i.e., a medium that in a current state can only be reproduced and cannot be recorded, the anykey serves to display a list of frequently used menus related to a reproducing operation. Namely, when the conventional anykey is operated, it is determined whether an optical disc inserted in a deck is a recordable medium or a reproducible-only medium, and a list of frequently used menus is displayed based on the determination.

However, in a conventional dual-deck optical disc system with a recording/reproducing deck and a reproducing deck, a deck that is currently being operated may be capable of performing both a recording operation and a reproducing operation, or may be capable of performing only a reproducing operation, depending on which deck is currently being operated. When the anykey function of the conventional dual-deck optical disc system is implemented based only on a type of a medium, such as an optical disc, inserted in the deck that is currently being operated, functions that cannot actually be used may be displayed, thereby confusing users. For example, when the anykey is operated while a recordable medium is inserted in a reproducing deck that is currently being operated, the displayed list of menus includes menus related to both a recording operation and a reproducing operation because the medium inserted in the reproducing deck is a recordable medium, even though the menu or menus related to a recording operation cannot actually be used because the reproducing deck cannot perform a recording operation. This confuses users.

Therefore, in order to avoid confusing users, it would be desirable to implement an anykey function based on both a type of a deck and a type of a medium, such as an optical disc, inserted in the deck.

### SUMMARY OF THE INVENTION

Therefore, in accordance with an aspect of the invention, there is provided an anykey executing device of an optical disc system including a recording/reproducing deck and a recording deck, and a method of executing an anykey function, that implement an anykey function based on both a type of a deck and a type of a medium inserted in the deck so that only menus that can actually be used are displayed when an anykey is operated, thereby avoiding confusing users.

In accordance with an aspect of the invention, there is provided a method of executing an anykey function of an optical disc system, the optical disc system including a recording/reproducing deck and a reproducing deck, the method including determining a type of an enabled deck; determining a type of an optical disc inserted in the enabled deck; and selecting a list of menus to be displayed from a list of available menus based on the type of the enabled deck and the type of the optical disc inserted in the enabled deck in response to operation of an anykey.

The selecting of a list of menus to be displayed may include selecting a reproduction-related menu list from the list of available menus when the enabled deck is the recording/reproducing deck and the optical disc inserted in the recording/reproducing deck is a reproducible-only optical disc; and the method may further include displaying the reproduction-related menu in response to the operation of the anykey.

The selecting of a list of menus to be displayed may include selecting a reproduction-related menu list from the list of available menus when the enabled deck is the reproducing deck and the optical disc inserted in the reproducing deck is a recordable optical disc; and the method may further include displaying the reproduction-related menu in response to the operation of the anykey.

The method may further include determining whether any optical disc is inserted in the enabled deck; the selecting of a list of menus to be displayed may include selecting a menu list not including recording-related menus and reproduction-related menus from the list of available menus when an optical disc is not inserted in the enabled deck; and the method may further include displaying the menu list not including recording-related menus and reproduction-related menus in response to the operation of the anykey.

In accordance with another aspect of the invention, there is provided a method of executing an anykey function of an optical disc system, the optical disc system including dual decks, the method including determining whether an enabled deck is a recording/reproducing deck or a reproducing deck; determining whether a medium inserted in the enabled deck is a recordable medium or a reproducible-only medium; and displaying a reproduction-related menu list in response to operation of an anykey when the enabled deck is the recording/reproducing deck and the medium inserted in the recording/reproducing deck is the reproducible-only medium, or when the enabled deck is the reproducing deck and the medium inserted in the reproducing deck is the recordable medium.

In accordance with another aspect of the invention, there is provided an anykey function executing device of an optical disc system, the optical disc system including dual decks, the anykey executing device including a controller that determines whether an enabled deck is a recording/reproducing deck or a reproducing deck; determines whether a medium inserted in the enabled deck is a recordable medium or a reproducible-only medium; determines a menu list based on the type of the enabled deck and the type of the medium inserted in the enabled deck in response to operation of an anykey; and displays the menu list in response to the operation of the anykey.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of various embodiments, taken in conjunction with the accompanying drawings of which:

FIG. 1 is a perspective view of an optical disc system according to an aspect of the invention;

FIG. 2 is a schematic block diagram of an optical disc system according to an aspect of the invention; and

FIG. 3 is a flow chart for describing a method for executing an anykey function based on types of decks and types of media in an optical disc system according to an aspect of the invention.

### DETAILED DESCRIPTION OF THE EMBODIMENTS

Reference will now be made in detail to various embodiments of the invention, examples of which are shown in the accompanying drawings, wherein like reference numerals refer to like elements throughout. The embodiments are described below to explain the invention by referring to the figures.

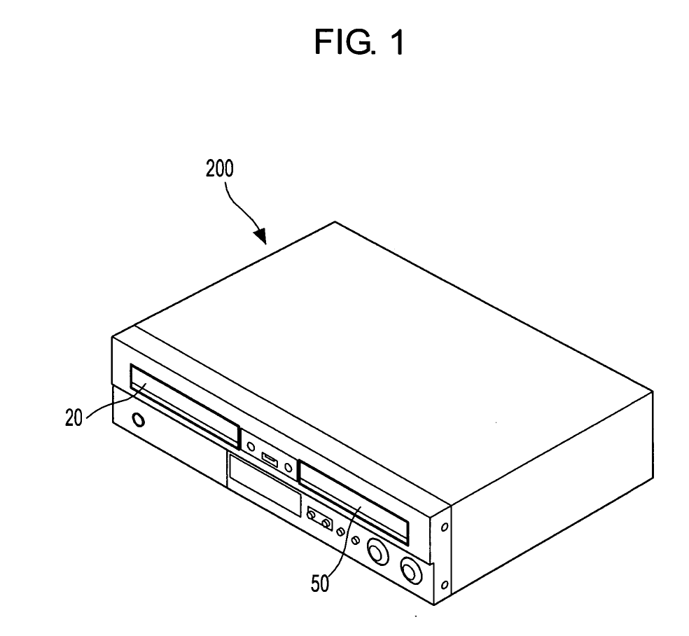

Referring to FIG. 1, an optical disc system 200 according to an aspect of the invention can operate so that data is copied from one optical disc inserted in a first deck 20 serving as a source onto another optical disc inserted in a second deck 50 serving as a destination (or a target). The optical disc system 200 can also perform multiple functions at once. For example, a broadcasting signal received by a TV, etc., can be recorded on an optical disc inserted in the first deck 20, while the second deck 50 reproduces audio/video data or music from an optical disc inserted in the second deck 50. The first deck 20 (hereinafter referred to as a recording/reproducing deck) serves as an optical disc recorder which can record data on and reproduce data from an optical disc, and the second deck 50 (hereinafter referred to as a reproducing deck) serves as an optical disc player which can only reproduce data from an optical disc.

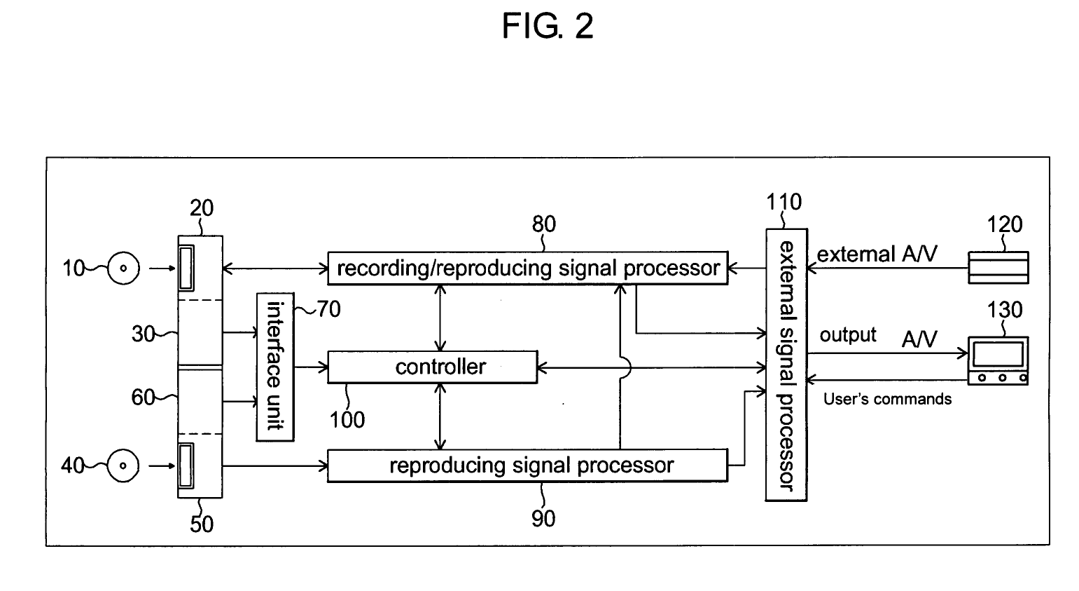

Referring to FIG. 2, the optical disc system 200 includes a recording/reproducing deck 20 operable to record data on and reproduce data from an optical disc 10 inserted therein, and a reproducing deck 50 operable only to reproduce data from an optical disc 40 inserted therein.

Optical discs that may be used in the optical disc system 200 include a DVD-ROM, a DVD-R, a DVD-RW, and a DVD-RAM, etc., which may have various formats, such as a Video (V) mode and a Video Recording (VR) mode. An optical disc that may be used in the optical disc system 200 may be a recordable optical disc, i.e. an optical disc that in a current state can be both recorded and reproduced, or a reproducible-only optical disc, i.e., an optical disc that in a current state can only be reproduced and cannot be recorded. For example, a DVD-ROM is a reproducible-only optical disc, while a DVD-R is a recordable optical disc. However, a recordable optical disc can become a reproducible-only optical disc under certain circumstances. For example, a DVD-R, which is initially a recordable optical disc, can become a reproducible-only optical disc under certain circumstances, such as when it is full, finalized, or write-protected. Such a DVD-R is a reproducible-only optical disc because in a current state, it can only be reproduced and cannot be recorded. Also, a recordable optical disc may be a write-once optical disc, such as a DVD-R, or a rewritable optical disc, such as a DVD-RW. Which types of optical discs are recordable discs, which types of optical discs are reproducible-only discs, and the circumstances under which recordable optical discs can become reproducible-only optical discs are known in the art, and accordingly a detailed description thereof will not be provided.

The recording/reproducing deck 20 includes an optical pick-up and an optical pick-up driver that drives the optical pick-up to emit a laser beam to record data on and reproduce data from the optical disc 10, and the reproducing deck 50 includes an optical pick-up and an optical pick-up driver that drives the optical pick-up to emit a laser beam to reproduce data from the optical disc 40. These optical pick-ups and optical pick-up drivers are not shown in FIG. 2.

The recording/reproducing deck 20 includes a first key input unit 30 that enables a user to input commands to control operations of the recording/reproducing deck 20. The reproducing deck 50 includes a second key input unit 60 that enables a user to input commands to control operations of the reproducing deck 50. The first key input unit 30 and the second key input unit 60 may be integrated into a single key input unit.

An interface unit 70 receives commands inputted by a user through the first key input unit 30 and the second key input unit 60, and transmits the commands to a controller 100. The controller 100 controls various elements of the optical disc system in response to these commands.

A recording/reproducing signal processor 80 encodes data reproduced from the optical disc 10 by the recording/reproducing deck 20, and transmits the encoded data to an external signal processor 110. Also, the recording/reproducing signal processor 80 decodes processed external audio/video signals received from the external signal processor 110 to obtain recording data, and transmits the recording data to the recording/reproducing deck 20 for recording on the optical disc 10. Also, the recording/reproducing signal processor 80 transmits data reproduced from the optical disc 40 by the reproducing deck 50 received from a reproducing signal processor 90 to the recording/reproducing deck 20 for recording on the optical disc 10.

The reproducing signal processor 90 encodes data reproduced from the optical disc 40 by the reproducing deck 50, and transmits the encoded data to the external signal processor 110. Also, the reproducing signal processor 90 transmits the data reproduced from the optical disc 40 to the recording/reproducing signal processor 80 for recording on the optical disc 10 by the recording/reproducing deck 20.

The external signal processor 110 processes the encoded data received from the recording/reproducing signal processor 80 or the reproducing signal processor 90 to obtain output audio/video signals (output A/V), and transmits the output audio/video signals to a TV 130. Also, the external signal processor 110 processes external audio/video signals (external A/V) received from a tuner 120, and transmits the processed external audio/video signals to the recording/reproducing signal processor 80. Also, the external signal processor 110 processes the external audio/video signals received from the tuner 120 to output audio/video signals, and transmits the output audio/video signals to the TV 130.

The external signal processor also receives commands from the TV 130 inputted by a user with a TV input key, a menu key, or an anykey provided on a remote controller, and transmits the commands to the controller 100. The controller controls various elements of the optical disc system in response to these commands. The user inputs these commands with the help of guide messages displayed on the TV 130.

In particular, the controller 100 displays a list of menus on the TV 130 through the external signal processor 110 when the user presses the anykey provided on the remote controller, thereby making it easy for the user to select a menu from the list of menus and input a command using the selected menu.

A recording/reproducing deck selection key for enabling operation of the recording/reproducing deck 20 is provided on the key unit 30 and/or the remote controller. A recording deck selection key for enabling operation of the reproducing deck 50 is provided on the key input 60 and/or the remote controller. Only one deck can be enabled at any given time. Thus, if the recording/reproducing deck 20 is currently the enabled deck and the reproducing deck selection key is pressed, the reproducing deck 40 becomes the enabled deck. In contrast, if the reproducing deck 40 is currently the enabled deck and the recording/reproducing deck selection key is pressed, the recording/reproducing deck 20 becomes the enabled deck. The controller 100 determines whether the enabled deck is the recording/reproducing deck 20 or the a reproducing deck based on the current state of the recording/reproducing deck selection key and the current state of the reproducing deck selection key.

The controller 100 obtains basic data about the optical disc 10 inserted in the recording/reproducing deck 20 from the recording/reproducing signal processor 80, and determines whether the optical disc 10 is a recordable medium, i.e., a medium that in a current state can be both recorded and reproduced, or a reproducible-only medium, i.e., an optical disc that in a current state can only be reproduced and cannot be recorded, based on this basic data. If the optical disc 10 is not inserted in the recording/reproducing deck 10, the recording/reproducing signal processor 80 provides information to that effect to the controller 100. Also, the controller 100 obtains basic data about the optical disc 40 inserted in the reproducing deck 50 from the reproducing signal processor 90, and determines whether the optical disc 40 is a recordable medium or a reproducible-only medium based on this basic data. If the optical disc 40 is not inserted in the reproducing deck 50, the reproducing signal processor 90 provides information to that effect to the controller 100.

More specifically, the controller 100 operates as follows. When a user presses the anykey while the recording/reproducing deck 20 is enabled and a medium, i.e., the optical disc 10, is inserted in the recording/reproducing deck 20, the controller 100 displays a list of menus related to recording and reproducing operations on the TV 130 through the external signal processor 110 if the medium is a recordable medium, or displays a list of menus related to only a reproducing operation on the TV 130 through the external signal processor 110 if the medium is a reproducible-only medium. When the user presses the anykey while the recording deck 50 is enabled and a medium, i.e., the optical disc 40, is inserted in the recording deck 50, the controller 100 displays a list of menus related to only a reproducing operation on the TV 130 through the external signal processor 110 regardless of whether the medium is a recordable medium or a reproducible-only medium. Therefore, even if a recordable medium is inserted in the reproducing deck 50, the controller 100 displays a list of menus that does not include menus related to a recording operation, since such menus cannot actually be used because the reproducing deck 50 cannot perform a recording operation. Accordingly, an optical disc system according to an aspect of the invention does not confuse a user by displaying menus that cannot actually be used as may occur in a conventional optical disc system.

A method of implementing an anykey function based on both a type of a deck and a type of a medium inserted in the deck in an optical disc system according to an aspect of the invention will now be described.

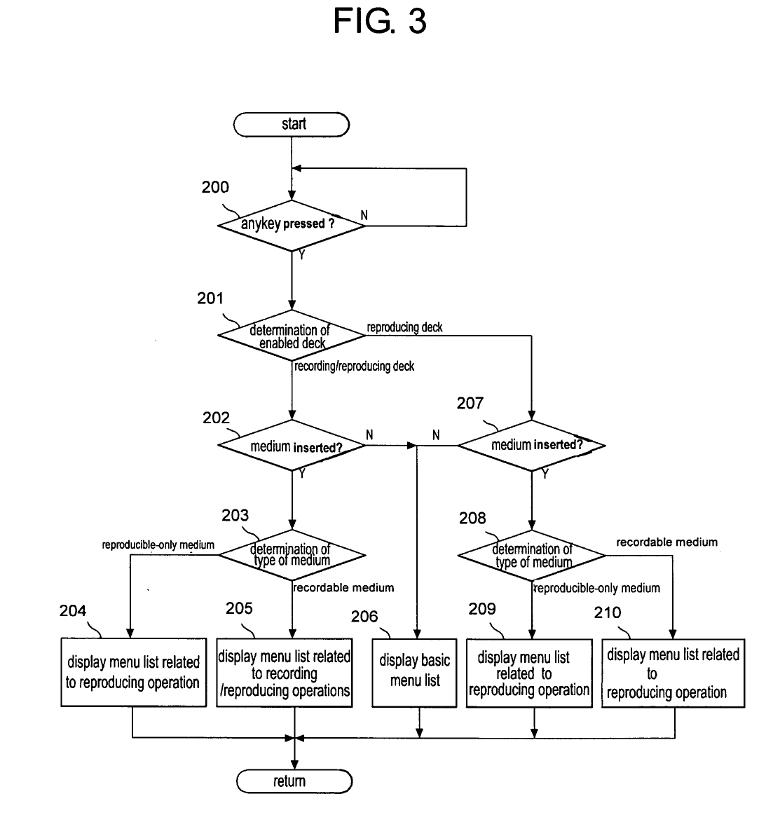

Referring to FIG. 3, the controller 100 determines whether an anykey has been pressed (block 200). When the controller 100 determines that the anykey has been pressed, the controller 100 then determines whether the enabled deck is the recording/reproducing deck 20 or the reproducing deck 50 (block 201). The controller 100 makes this determination based on the current state of the recording/reproducing deck selection key and the current state of the reproducing deck selection key as described above.

When the controller 100 determines in the block 201 that the enabled deck is the recording/reproducing deck 20, the controller 100 determines whether a medium, i.e., the optical disc 10, is inserted in the recording/reproducing deck 20 (block 202). The controller 100 makes this determination based on the information provided by the recording/reproducing signal processor 80 indicating whether or not the optical disc 10 is inserted in the recording/reproducing deck 20 as described above.

When the controller 100 determines in the block 202 that a medium is inserted in the recording/reproducing deck 20, the controller 100 determines a type of the medium (block 203). Namely, the controller 100 determines whether the medium is a recordable medium or a reproducible-only medium based on basic data about the medium, i.e., the optical disc 10, inserted in the recording/reproducing deck 20 obtained from the recording/reproducing signal processor 80 as described above.

When the controller 100 determines in the block 203 that the medium inserted in the recording/reproducing deck 20 is a reproducible-only medium, the controller 100 displays a list of menus related only to a reproducing operation on the TV 130 through the external signal processor 110 (block 204). On the other hand, when the controller 100 determines in the block 203 that the medium inserted in the recording/reproducing deck 20 is a recordable medium, the controller 100 displays a list of menus related to recording/reproducing operations on the TV 130 through the external signal processor 110 (block 205).

When the controller 100 determines in the block 201 that the enabled deck is the reproducing deck 50, the controller 100 determines whether a medium, i.e., the optical disc 40, is inserted in the reproducing deck 50 (block 207). The controller 100 makes this determination based on the information provided by the reproducing signal processor 90 indicating whether or not the optical disc 40 is inserted in the reproducing deck 50 as described above.

When the controller 100 determines in the block 207 that a medium is inserted in the reproducing deck 50, the controller 100 determines a type of the medium (block 208). Namely, the controller 100 determines whether the medium is a recordable medium or a reproducible-only medium based on basic data about the medium, i.e., the optical disc 40, inserted in the reproducing deck 50 obtained from the reproducing signal processor 90 as described above.

When the controller 100 determines in the block 208 that the medium inserted in the reproducing deck 50 is a reproducible-only medium, the controller 100 displays a list of menus related only to a reproducing operation on the TV 130 through the external signal processor 110 (block 209). Likewise, when the controller 100 determines in the block 208 that the medium inserted in the reproducing deck 50 is a recordable medium, the controller 100 displays a list of menus related only to a reproducing operation on the TV 130 through the external signal processor 110 (block 210). Here, even though the medium inserted in the reproducing deck 50 is a recordable medium, the list of menus does not include any menus related to a recording operation because the reproducing deck 50 cannot perform a recording operation. Therefore, the optical disc system according to an aspect of the invention does not confuse users.

When the controller determines in the blocks 202 and 207 that a medium is not inserted in either of the recording/reproducing deck 20 and the reproducing deck 50, the controller 100 displays a basic menu list on the TV 130 through the external signal processor 110 (block 206). Here, the basic menu list does not include any menus relating to a reproducing operation and a recording operation.

As described above, in accordance with an aspect of the invention, an anykey function of an optical disc system is implemented based on both a type of a deck and a type of a medium inserted in the deck so that only menus that can actually be used are displayed when an anykey is operated. Therefore, an optical disc system according to an aspect of the invention can prevent users from being confused, and is convenient for the users to use.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of executing an anykey function of an optical disc system, the optical disc system comprising a recording/reproducing deck and a reproducing deck, the method comprising:
determining a type of an enabled deck;
determining a type of an optical disc inserted in the enabled deck; and
selecting a list of menus to be displayed from a list of available menus based on the type of the enabled deck and the type of the optical disc inserted in the enabled deck in response to operation of an anykey.

2. The method of claim 1, wherein only one of the recording/reproducing deck and the reproducing deck can be enabled at one time.

3. The method of claim 1, wherein the reproducing deck can only reproduce and cannot record.

4. The method of claim 1, wherein the selecting of a list of menus to be displayed comprises selecting a reproduction-related menu list from the list of available menus when the enabled deck is the recording/reproducing deck and the optical disc inserted in the recording/reproducing deck is a reproducible-only optical disc; and
wherein the method further comprises displaying the reproduction-related menu list in response to the operation of the anykey.

5. The method of claim 4, wherein the reproducible-only optical disc is an optical disc that in a current state can only be reproduced and cannot be recorded.

6. The method of claim 1, wherein the selecting of a list of menus to be displayed comprises selecting a recording/reproduction-related menu list from the list of available menus when the enabled deck is the recording/reproducing deck and the optical disc inserted in the recording/reproducing deck is a recordable optical disc; and
wherein the method further comprises displaying the recording/reproduction-related menu list in response to the operation of the anykey.

7. The method of claim 6, wherein the recordable optical disc is an optical disc that in a current state can be both recorded and reproduced.

8. The method of claim 6, wherein the recordable optical disc is a write-once optical disc or a rewritable optical disc.

9. The method of claim 1, wherein the selecting of a list of menus to be displayed comprises selecting a reproduction-related menu list from the list of available menus when the enabled deck is the reproducing deck and the optical disc inserted in the reproducing deck is a recordable optical disc; and
wherein the method further comprises displaying the reproduction-related menu list in response to the operation of the anykey.

10. The method of claim 9, wherein the recordable optical disc is an optical disc that in a current state can be both recorded and reproduced.

11. The method of claim 9, wherein the recordable optical disc is a write-once optical disc or a rewritable optical disc.

12. The method of claim 1, wherein the selecting of a list of menus to be displayed comprises selecting a reproduction-related menu list from the list of available menus when the enabled deck is the reproducing deck and the optical disc inserted in the reproducing deck is a reproducible-only optical disc; and
wherein the method further comprises displaying the reproduction-related menu list in response to the operation of the anykey.

13. The method of claim 12, wherein the reproducible-only optical disc is an optical disc that in a current state can only be reproduced and cannot be recorded.

14. The method of claim 1, further comprising determining whether any optical disc is inserted in the enabled deck;
wherein the selecting of a list of menus to be displayed comprises selecting a menu list not comprising recording-related menus and reproduction-related menus from the list of available menus when an optical disc is not inserted in the enabled deck; and
wherein the method further comprises displaying the menu list not comprising recording-related menus and reproduction-related menus in response to the operation of the anykey.

15. A method of executing an anykey function of an optical disc system, the optical disc system comprising dual decks, the method comprising:
determining whether an enabled deck is a recording/reproducing deck or a reproducing deck;
determining whether a medium inserted in the enabled deck is a recordable medium or a reproducible-only medium; and
displaying a reproduction-related menu list in response to operation of an anykey when the enabled deck is the recording/reproducing deck and the medium inserted in the recording/reproducing deck is the reproducible-only medium, or when the enabled deck is the reproducing deck and the medium inserted in the reproducing deck is the recordable medium.

16. The method of claim 15, wherein only one of the dual decks can be enabled at one time.

17. The method of claim 15, wherein the dual decks comprise a recording/reproducing deck and a reproducing deck.

18. The method of claim 15, wherein the reproducing deck can only reproduce and cannot record.

19. The method of claim 15, wherein the recordable medium is a medium that in a current state can be both recorded and reproduced.

19. The method of claim 15, wherein the recordable medium is a write-once medium or a rewritable medium.

20. The method of claim 15, wherein the reproducible-only medium is a medium that in a current state can only be reproduced and cannot be recorded.

21. The method of claim 15, further comprising:
displaying a recording/reproduction-related menu list in response to the operation of the anykey when the enabled deck is the recording/reproducing deck and the medium inserted in the recording/reproducing deck is the recordable medium; and
displaying a reproduction-related menu in response to the operation of the anykey when the enabled deck is the reproducing deck and the medium inserted in the reproducing deck is the reproducible-only medium.

22. An anykey function executing device of an optical disc system, the optical disc system comprising dual decks, the anykey executing device comprising a controller that:
determines whether an enabled deck is a recording/reproducing deck or a reproducing deck;
determines whether a medium inserted in the enabled deck is a recordable medium or a reproducible-only medium;
determines a menu list based on the type of the enabled deck and the type of the medium inserted in the enabled deck in response to operation of an anykey; and
displays the menu list in response to the operation of the anykey.

23. The anykey function executing device of claim 22, wherein the menu list comprises only menus that can actually be used with the enabled deck

24. An optical disc system comprising:
a recording/reproducing deck;
a recording deck; and
an anykey function executing device;
wherein the anykey function executing device comprises a controller that:
determines whether an enabled deck is the recording/reproducing deck or the reproducing deck;
determines whether a medium inserted in the enabled deck is a recordable medium or a reproducible-only medium;
determines a menu list based on the type of the enabled deck and the type of the medium inserted in the enabled deck in response to operation of an anykey; and
displays the menu list in response to the operation of the anykey.

25. The optical disc system of claim 24, wherein the menu list comprises only menus that can actually be used with the enabled deck

26. The optical disc system of claim 24, further comprising a remote controller operable to control the optical disc system;
wherein the anykey is provided on the remote controller.
